(19) United States
(12) Patent Application Publication
(10) Pub. No.: US 2012/0050499 A1
(43) Pub. Date: Mar. 1, 2012

(54) Information Output Control Apparatus

(76) Inventor: Hideaki Okumoto, Fukaya-shi (JP)

(21) Appl. No.: 13/099,034

(22) Filed: May 2, 2011

(30) Foreign Application Priority Data
Aug. 31, 2010 (JP) 2010-195046

(51) Int. Cl. H04N 13/04

(52) U.S. Cl. 348/51; 348/E13.075

(57) ABSTRACT

According to one embodiment, there is provided an information output control apparatus, including: a reception module configured to receive a 3D or 2D video signal; a video processor configured to output a 3D or 2D video signal, based on the received video signal; an indicator configured to be turned on/off; and a controller configured to control lighting/non-lighting of the indicator, wherein the video processor includes a conversion module configured to perform a conversion processing to convert the received 3D video signal into the 2D video signal, and wherein the controller controls the lighting/non-lighting of the indicator in accordance with an operating state of the video processor to thereby indicate whether the conversion processing is being performed or not.

### CROSS-REFERENCE TO RELATED APPLICATION(S)

This application is based upon and claims the benefit of priority from Japanese Patent Application No. 2010-195046, filed on Aug. 31, 2010, the entire contents of which are incorporated herein by reference.

### FIELD

Embodiments described herein relate generally to an information output control apparatus and an information output control method which control output of various kinds of guide information.

### BACKGROUND

Display of three-dimensional (3D) video has come to be desired in recent years and it is expected that TV receivers, DVD players, etc. that accommodate 3D video will spread in the future. Such 3D-compatible apparatus may have a function of converting a two-dimensional (2D) signal of a content into a 3D video signal (2D-to-3D conversion) and outputting the latter. There also exist 3D-compatible apparatus which have an opposite function of converting a 3D video signal of a content into a 2D video signal (3D-to-2D conversion) and outputting the latter.

Some apparatuses have the 3D-to-2D converting function. An example of such apparatus is a TV receiver which is provided with a setting item for allowing the user to view 2D video by turning on the 3D-to-2D converting function automatically if it is judged that a received content is of 3D.

However, when the user views the 2D video content in a state where such 3D-to-2D conversion function is turned on, the user may not recognize whether the viewed content is of 2D originally or converted from 3D originally. In such a case, the user may miss an opportunity to enjoy, in 3D, a content of 3D originally.

### BRIEF DESCRIPTION OF DRAWINGS

A general architecture that implements the various feature of the present invention will now be described with reference to the drawings. The drawings and the associated descriptions are provided to illustrate embodiments and not to limit the scope of the present invention.

FIG. 1 illustrates an appearance of a TV broadcast receiver according to a first embodiment.

FIG. 2 illustrates a signal processing system of the TV broadcast receiver according to the first embodiment.

FIG. 3 illustrates a selection menu which prompts the user to judge whether to perform an automatic 3D-to-2D converting function displayed on a video display module in the first embodiment.

FIG. 4 illustrates a signal processing system of a TV broadcast receiver according to a second embodiment.

FIG. 5 illustrates GUI guide information displayed on the video display module in the second embodiment.

FIG. 6 illustrates another piece of GUI guide information displayed on the video display module in the second embodiment.

### DETAILED DESCRIPTION

In general, according to one embodiment, there is provided an information output control apparatus, including: a reception module configured to receive a 3D or 2D video signal; a video processor configured to output a 3D or 2D video signal, based on the received video signal; an indicator configured to be turned on/off; and a controller configured to control lighting/non-lighting of the indicator, wherein the video processor includes a conversion module configured to perform a conversion processing to convert the received 3D video signal into the 2D video signal, and wherein the controller controls the lighting/non-lighting of the indicator in accordance with an operating state of the video processor to thereby indicate whether the conversion processing is being performed or not.

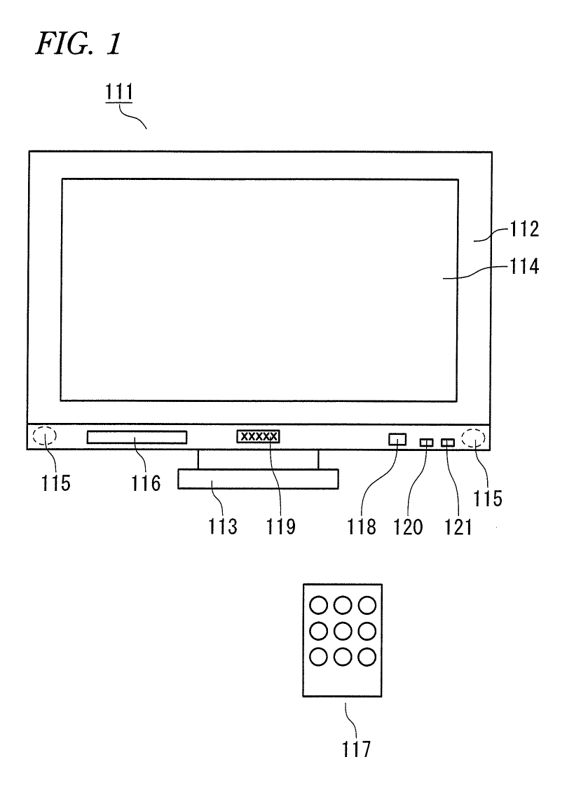

A first embodiment will be hereinafter described with reference to the drawings. FIG. 1 schematically illustrates an example appearance of a TV broadcast receiver 111 according to the first embodiment.

The TV broadcast receiver 111 is mainly composed of a thin cabinet 112 and a support stage 113 for supporting the cabinet 112 which is erected. The term “cabinet” may be used in such a sense as to include the support stage 113. The cabinet 112 is equipped with a video display module 114 which is a flat panel display having a liquid crystal display panel, a plasma display panel, or the like, a pair of speakers 115, a manipulation module 116, a remote control light receiving module 118 for receiving manipulation information that is transmitted from a remote controller 117, and other modules. The manipulation module 116 may be provided in a side wall, rather than the front wall, of the cabinet 112.

An illuminated mark 119 is disposed in the front wall approximately at a bottom-center position (under the video display module 114). The illuminated mark 119 consists of characters or symbols (logo) indicating a company name, a type name, or the like and is illuminated by an LED light source, for example. The light source for the illuminated mark 119 is turned on when the TV broadcast receiver 111 is powered on, and is turned off when TV broadcast receiver 111 is powered off.

A power indicator 120 which indicates a power status of the TV broadcast receiver 111 is disposed in the front wall at a bottom-right position, that is, adjacent to the remote control light receiving module 118. The power indicator 120 is also illuminated by an LED light source, for example. The power indicator 120 may be disposed at any position.

Another indicator, that is, a 3D/3D-2D indicator 121, is disposed in the front wall at a bottom-right position, that is, adjacent to the power indicator 120. The 3D/3D-2D indicator 121 produces guide information meaning that 3D video is being displayed or 2D video is being displayed. The 3D/3D-indicator 121 of the embodiment at least indicates, in discriminated manners, that original 3D video is being displayed, 3D video (converted 3D video) generated by a 2D-to-3D converting function of a conversion-to-3D processor 254a (described later), original 2D video is being displayed, or 2D video (converted 2D video) generated by a 3D-to-2D converting function of a conversion-to-2D processor 254b (described later). The 3D/3D-2D indicator 121 is also illuminated by an LED light source, for example.

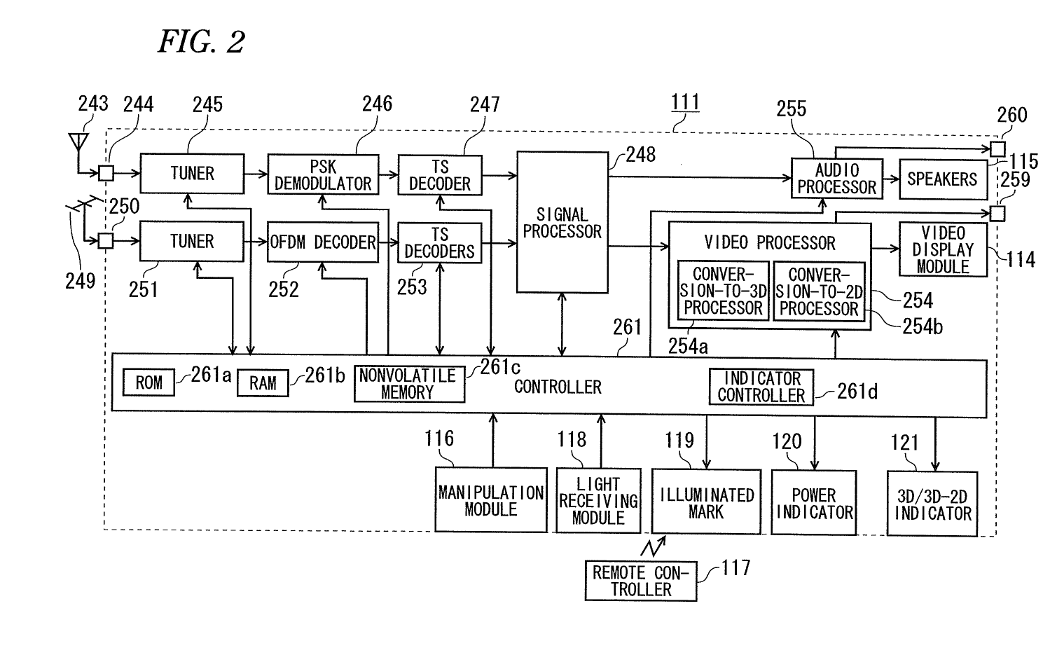

FIG. 2 illustrates a signal processing system of the TV broadcast receiver 111. Satellite digital TV broadcast signals received by a BS/CS digital broadcast receiving antenna 243 are supplied via an input terminal 244 to a satellite digital broadcast tuner 245, which tunes in to a broadcast signal on a desired channel.

The broadcast signal selected by the tuner 245 is supplied to a PSK (phase shift keying) demodulator 245b, where it is demodulated into a transport stream (TS). The transport stream is supplied to a TS decoder 247, where it is decoded into a digital video signal, audio signal, data signal, etc., which are output to a signal processor 248.

Ground-wave digital TV broadcast signals received by a ground-wave broadcast receiving antenna 249 are supplied via an input terminal 250 to a ground-wave digital broadcast tuner 251, which tunes in to a broadcast signal on a desired channel.

The broadcast signal selected by the tuner 251 is supplied to an OFDM (orthogonal frequency division multiplexing) demodulator 22, where it is demodulated into a transport stream. The transport stream is supplied to a TS decoder 253, where it is decoded into a digital video signal, audio signal, data signal, etc., which are output to the signal processor 248.

Ground-wave analog TV broadcast signals received by the ground-wave broadcast receiving antenna 249 are supplied via the input terminal 250 to a ground-wave analog broadcast tuner (not shown), which tunes in to a broadcast signal on a desired channel. The broadcast signal selected by this tuner is supplied to an analog demodulator (not shown), where it is demodulated into an analog video signal and audio signal, which are output to the signal processor 248.

During viewing of a TV program, the signal processor 248 performs prescribed digital signal processing selectively on the sets of digital video signal and audio signal supplied from TS decoders 247 and 253, respectively, and outputs a resulting video signal and audio signal to a video processor 254 and an audio processor 255, respectively. Each of the video signals supplied to the signal processor 248 may be a video signal of either a 3D video content or a 2D video content.

The video signal of a 3D video content is a side-by-side video signal, for example. The side-by-side scheme is a scheme in which each of a left-eye image (one frame) and a right-eye-image (one frame) is compressed by a factor of 2 in the horizontal direction and resulting frames are arranged side by side to produce a single frame to be transmitted. When receiving a side-by-side video signal, the TV broadcast receiver 111 expands a left-eye image and a right-eye image to images having the screen size and displays them alternately. The user sees the left-eye image and the right-eye image through the left eye and the right eye, respectively, using electronic shutter glasses (not shown) which operate in synchronism with the two kinds of images, and hence can recognize a 3D image.

The video signal scheme of a 3D video content that the TV broadcast receiver 111 accommodates may be, instead of the side-by-side scheme, a line-by-line scheme, a top-and-bottom scheme, a frame packing scheme, or the like. The 3D viewing method of the TV broadcast receiver 111 may be, instead of the method using electronic shutter glasses, a method using polarizing glasses or a method using no glasses (naked eye method). For example, in an integral imaging method (ray-regenerating method), a user can view 3D video without dedicated glasses because many light rays are produced at different angles.

A controller 261 receives, from the signal processor 248 and the TS decoders 247 and 253, various data for acquiring a program, electronic program guide (EPG) information, program attribute information (program genre etc.), and subtitle information etc. (service information (SI or PSI)). The controller 261 performs image generation processing for displaying an EPG or subtitles based on these kinds of received information, and outputs generated image information to the video processor 254.

The video processor 254 has a function of superimposing an OSD signal of a GUI (graphical user interface), for example, on a digital video signal supplied from the signal processor 248 and outputting a resulting video signal. The video processor 254 converts a received digital video signal into an analog video signal having such a format as to be displayable by the video display module 114 and outputs the generated analog video signal to the video display module 114 to display it. Furthermore, the video processor 254 can output a video signal to the outside via an output terminal 259.

The video processor 254 includes the conversion-to-3D processor 254a and the conversion-to-2D processor 254b. The conversion-to-3D processor 254a converts an original video signal (2D video signal) received from each antenna, a medium such as a DVD, the Internet, or the like into a 3D video signal and outputs the latter. That is, having a 2D-to-3D converting function, the conversion-to-3D processor 254a converts a received original video signal (2D video signal) into a 3D video signal and outputs the latter. Different kinds of 2D-to-3D conversion processing are performed for the above-mentioned various schemes, and 2D-to-3D conversion processing that will be exemplified below is performed and resulting 3D video is viewed. A right-eye image signal and a left-eye image signal of 3D video are generated, that is, a 3D video signal is generated, through various kinds of estimation processing such as estimating image composition from features of a received video signal (2D video signal), estimating positional relationships between plural objects in the depth direction by detecting their movements, and estimating the faces and bodies of humans. The 3D video signal that is output from the video processor 254 is displayed by the video display module 114. The user can view 3D video through the electronic shutter glasses.

The conversion-to-3D processor 254a converts an original video signal (3D video signal) received from each antenna, a medium such as a DVD, the Internet, or the like into a 2D video signal and outputs the latter. That is, having a 3D-to-2D converting function, the conversion-to-2D processor 254b converts a received original video signal (3D video signal) into a 2D video signal and outputs the latter. Different kinds of 2D-to-3D conversion processing are performed for the above-mentioned various schemes, and 3D-to-2D conversion processing that will be exemplified below is performed and resulting 2D video is viewed. A 2D video signal is generated by processing a received video signal (3D video signal) so that only one (e.g., right-eye video signal) of a right-eye video signal and a left-eye image signal of the received video signal is output. The 2D video signal that is output from the video processor 254 is displayed by the video display module 114, and the user can thus view 2D video.

The video processor 254 can thus output any of a converted 2D video signal obtained by 3D-to-2D conversion, a converted 3D video signal obtained by 2D-to-3D conversion, an original 2D video signal (neither 3D-to-2D conversion nor 2D-to-3D conversion is performed), and an original 3D video signal (neither 3D-to-2D conversion nor 2D-to-3D conversion is performed).

The audio processor 255 converts a received digital audio signal into analog audio signals having such a format as to be reproducible by the speakers 115, and outputs the generated analog audio signals to the speakers 115 to reproduce a sound. An audio signal can be output to the outside via an output terminal 260.

The controller 261 supervises all operations of the TV broadcast receiver 111 including various receiving operations described above. Incorporating a CPU (central processing unit), a microcomputer, etc., the controller 261 receives manipulation information that is supplied from the manipulation module 116 or transmitted from the remote controller 117 and received by the light receiving module 118 and controls individual modules so that their operations reflect the content of the manipulation.

In doing to, the controller 261 uses a ROM (read-only memory) 261a which is stored with control programs to be run by the CPU, a RAM (random access memory) 261b for providing a work area for the CPU, and a nonvolatile memory 261c which is stored with an on-timer time, various kinds of setting information and control information, etc.

The controller 261 includes an indicator controller 261d. The indicator controller 261d controls the lighting/non-lighting of various indicators including the power indicator 120 and the 3D/3D-2D indicator 121 of the TV broadcast receiver 111. Since as described later the power indicator 120 and the 3D/3D-2D indicator 121 indicate, through lighting, non-lighting, etc., various kinds of information such as a power status and whether the 3D-to-2D converting function is being performed, the indicator controller 261d can also be called an information output controller like an information output controller 261e.

More specifically, for example, the lighting/non-lighting of each of the power indicator 120 and the 3D/3D-2D indicator 121 is controlled in the following manner. When a main power button provided in the manipulation module 116 is pressed, the TV broadcast receiver 111 is powered on and the power indicator 120 is lit in green, for example. If the main power button is pressed again, the TV broadcast receiver 111 is powered off, whereupon the video display and the audio output are stopped and the power indicator 120 is turned off.

If a power button of the remote controller 117 is pressed in a state that the TV broadcast receiver 111 is powered on, the video display and the audio output are stopped and the lighting color of the power indicator 120 is changed from green to red or yellow, for example. That is, a standby state is established in which only part of the internal circuits are in operation. If the power button of the remote controller 117 is pressed in the standby state, the lighting color of the power indicator 120 is changed from red or yellow, for example, to green and the TV broadcast receiver 111 comes to display prescribed video and output a sound. In the embodiment, the state that video and a sound are being output is called a power-on state (operation state) of the TV broadcast receiver 111, and the state that neither video nor a sound is being output is called a power-off state. The power-on state includes not only a state that the main power is off but also the above-mentioned standby state (in the embodiment, the state that the TV broadcast receiver 111 is powered off because of pressing of the power button of the remote controller 117). As described above, the power indicator 120 has a mode for indicating that the TV broadcast receiver 111 is powered off (the power indicator 120 is turned off or lit in red or yellow) and a mode for indicating that the TV broadcast receiver 111 is powered on (the power indicator 120 is lit in green).

If the video processor 254 is outputting a received original 3D video signal (i.e., 3D video is being displayed on the video display module 114) in a state that the TV broadcast receiver 111 is powered on, the 3D/3D-2D indicator 121 is lit in blue, for example.

If the video processor 254 is performing 3D-to-2D conversion processing on an original 3D video signal (i.e., 2D video is being displayed on the video display module 114) in a state that the TV broadcast receiver 111 is powered on, the 3D/3D-2D indicator 121 is lit in white, for example.

If the video processor 254 is outputting a received original 2D video signal (i.e., 2D video is being displayed on the video display module 114) in a state that the TV broadcast receiver 111 is powered on, the 3D/3D-2D indicator 121 is, for example, kept off.

If the video processor 254 is performing 2D-to-3D conversion processing on an original 2D video signal (i.e., 3D video is being displayed on the video display module 114) in a state that the TV broadcast receiver 111 is powered on, the 3D/3D-2D indicator 121 is lit in purple, for example.

As mentioned above, the power indicator 120 has the mode for indicating that the TV broadcast receiver 111 is powered off (the power indicator 120 is turned off or lit in red or yellow) and the mode for indicating that the TV broadcast receiver 111 is powered on (the power indicator 120 is lit in green). On the other hand, the 3D/3D-2D indicator 121 has a mode for indicating that original 3D video is being displayed (the 3D/3D-2D indicator 121 is lit in blue), a mode for indicating that 3D video obtained through 2D-to-3D conversion processing of the conversion-to-3D processor 254a is being displayed (the 3D/3D-2D indicator 121 is lit in white), a mode for indicating that original 2D video is being displayed (the 3D/3D-2D indicator 121 is kept off), and a mode for indicating that 2D video obtained through 3D-to-2D conversion processing of the conversion-to-2D processor 254b is being displayed (the 3D/3D-2D indicator 121 is lit in purple).

To discriminate between the roles of the power indicator 120 and the 3D/3D-2D indicator 121, it is preferable that their possible lighting colors be different from each other. Where the video processor 254 is outputting a received original 2D video signal (2D video is displayed on the video display module 114) in a state that the TV broadcast receiver 111 is powered on, the 3D/3D-2D indicator 121 may be lit in yellow, for example, instead of being kept off.

The TV broadcast receiver 111 has an automatic 3D-to-2D converting function. More specifically, the TV broadcast receiver 111 is provided with a mode in which if judging that a received content is of 3D, the controller 261 performs a control so that the conversion-to-2D processor 254b performs 3D-to-2D converting processing automatically. For example, if a received video signal contains an identifier indicating that the video signal is of a 3D content, the controller 261 judges that the received video signal is of a 3D content by detecting the identifier.

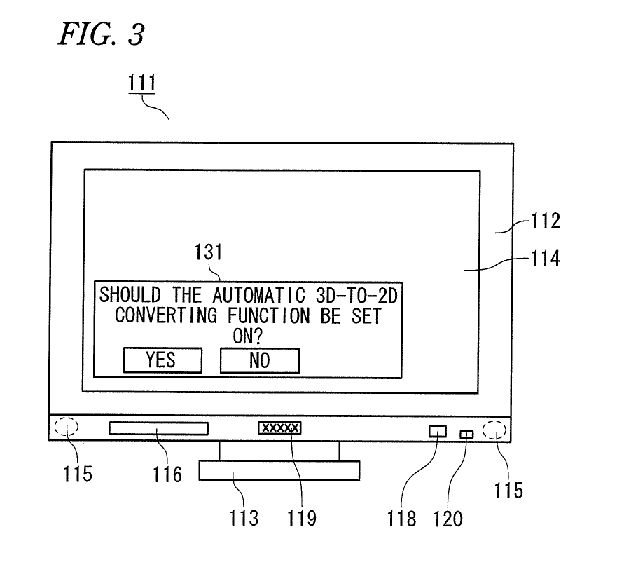

For example, as shown in FIG. 3, the controller 261 performs a control so that a selection menu 131 which prompts the user to judge whether to perform the automatic 3D-to-2D converting function is displayed in response to a manipulation of the manipulation module 116 or the remote controller 117. If the user selects “yes” and the controller 261 judges that a received content is of 3D, the automatic 3D-to-2D converting function is performed by the conversion-to-2D processor 254b. Likewise, the TV broadcast receiver 111 may be configured so as to have an automatic 2D-to-3D converting function and to display a selection menu which prompts the user to judge whether to perform the automatic 2D-to-3D converting function. As such, the controller 261 of the TV broadcast receiver 111 is provided with a judging module for judging whether a received video signal is of 3D or 2D and a selection menu display controller for performing a control so that the selection menu 131 which allows the user to make a setting as to whether to convert the 3D video signal into a 2D video signal automatically is displayed if the judging module judges that the received video signal is of 3D.

As described above, in the first embodiment, the lighting/non-lighting of the 3D/3D-2D indicator 121 is controlled differently when a received original 2D video signal is being output from the video processor 254 and 2D video is being displayed on the video display module 114, when a received original 3D video signal is being output from the video processor 254 and 3D video is being displayed on the video display module 114, when a 2D video signal generated by the 3D-to-2D converting function is being output from the video processor 254 and 2D video is being displayed on the video display module 114, and when a 3D video signal generated by the 2D-to-3D converting function is being output from the video processor 254 and 3D video is being displayed on the video display module 114. Therefore, the user can easily discriminate between a state that the 2D-to-3D converting function is being performed, a state that the 3D-to-2D converting function is being is being performed, a state that neither of these functions is being performed, and other states by checking information produced by the 3D/3D-2D indicator 121 (i.e., the manner of lighting or non-lighting).

The first embodiment can be applied preferably to TV receivers that are provided with a setting item for the automatic 3D-to-2D converting function (see FIG. 3). Conventionally, where the automatic 3D-to-2D converting function is set on, the user may not recognize whether he or she is viewing a 2D video content that is of 2D originally or a 2D video content produced by converting a content that is of 3D originally by the 3D-to-2D converting function. In contrast, in the first embodiment, the user can recognize whether or not the 3D-to-2D converting function is being performed by checking the manner of lighting/non-lighting of the 3D/3D-2D indicator 121. Therefore, even if the automatic 3D-to-2D converting function is set on, the user can enjoy, in 3D, original 3D video of a prescribed content he or she wants to view in 3D by turning off the 3D-to-2D converting function through the selection menu 131.

Next, a second embodiment will be described. The second embodiment is different from the first embodiment in that the same pieces of information as in the first embodiment are provided for the user in the form of GUI guide information rather than information produced by an indicator.

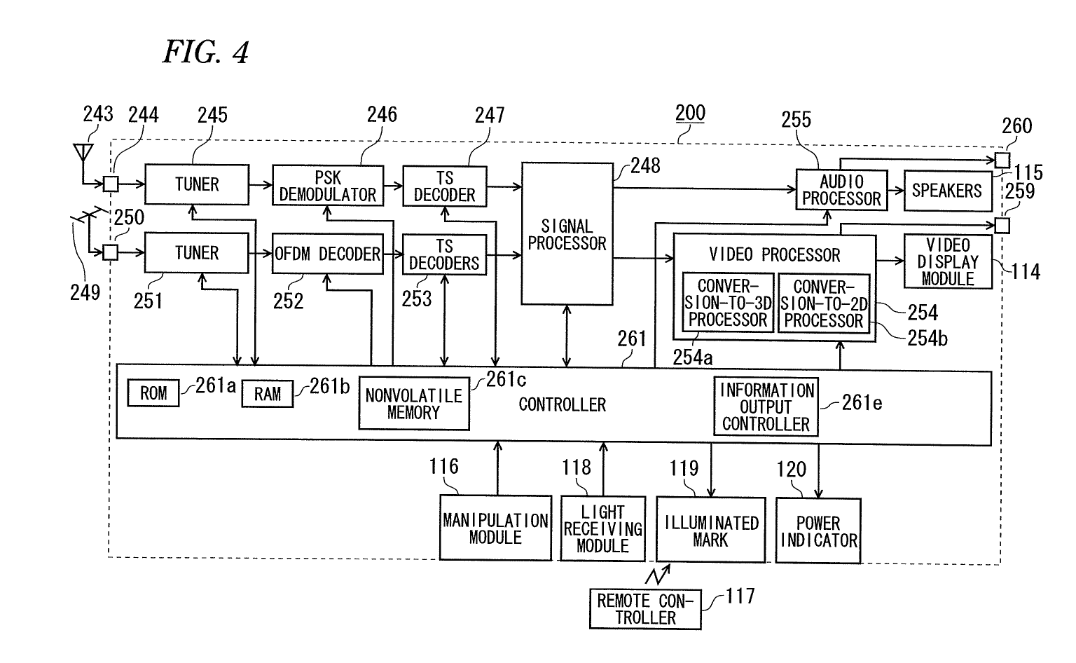

A TV broadcast receiver 200 according to the second embodiment will be described below with reference to FIGS. 4-6. Modules etc. having the same ones in the first embodiment will be given the same reference symbols as the latter and descriptions therefor will be omitted or simplified.

FIG. 4 illustrates a signal processing system of the TV broadcast receiver 200 according to the second embodiment.

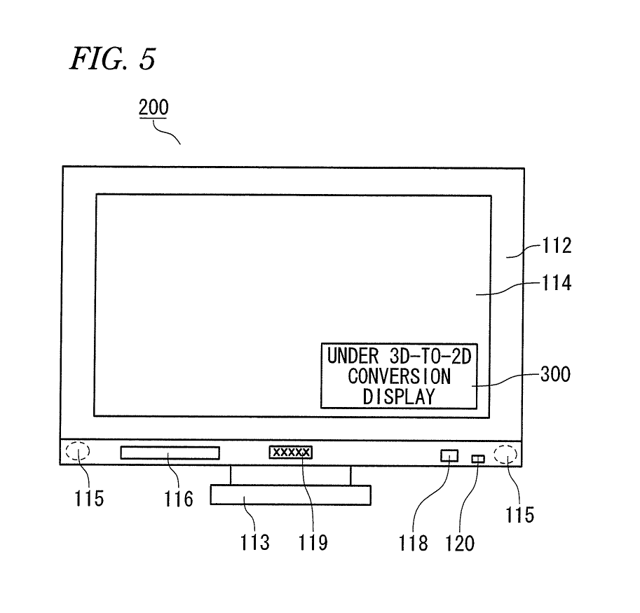

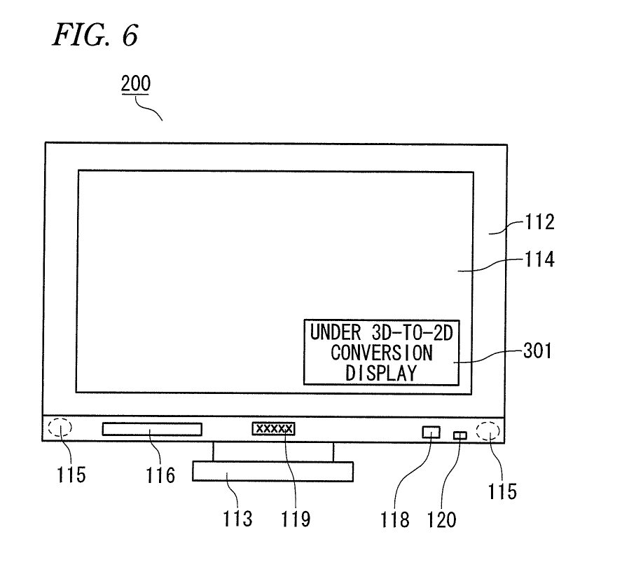

The controller 261 includes an information output controller 261e. The information output controller 261e controls the video processor 254 so that it outputs a (3D or 2D) video signal and GUI guide information as shown in FIG. 5 or 6. More specifically, when 2D video is being displayed through conversion by the 3D-to-2D converting function (i.e., 3D-to-2D conversion processing is being performed), the information output controller 261e controls the video processor 254 so that it outputs, for example, guide information 300 indicating that 3D-to-2D conversion display is being made (see FIG. 5). It is preferable that the guide information 300 be displayed for a prescribed time in response to broadcast channel switching processing which is commanded through the remote controller 117 or the manipulation module 116, and disappear upon a lapse of the prescribed time. This prevents the guide information 300 from obstructing viewing of the video.

When the video processor 254 is outputting a received original 3D video signal (i.e., 3D video is being displayed on the video display module 114) in a state that the TV broadcast receiver 111 is powered on, guide information to that effect (e.g., “Under 3D display”) may be displayed.

When the video processor 254 is outputting a received original 2D video signal (i.e., 2D video is being displayed on the video display module 114) in a state that the TV broadcast receiver 111 is powered on, the TV broadcast receiver 111 can refrain from displaying guide information.

When the video processor 254 is outputting a 3D video signal generated through conversion of an original 2D video signal by the conversion-to-3D processor 254a (i.e., 3D video is being displayed on the video display module 114) in a state that the TV broadcast receiver 111 is powered on, guide information 301 to that effect, for example, may be displayed as shown in FIG. 6.

As described above, in the second embodiment, different pieces of GUI guide information are displayed so as to be superimposed on video or no GUI guide information is displayed when a received original 2D video signal is being output from the video processor 254 and being displayed on the video display module 114, when a received original 3D video signal is being output from the video processor 254 and 3D video is being displayed on the video display module 114, when a 2D video signal generated by the 3D-to-2D converting function is being output from the video processor 254 and 2D video is being displayed on the video display module 114, and when a 3D video signal generated by the 2D-to-3D converting function is being output from the video processor 254 and 3D video is being displayed on the video display module 114. Therefore, the user can easily discriminate between a state that the 2D-to-3D converting function is being performed, a state that the 3D-to-2D converting function is being is being performed, a state that neither of these functions is being performed, and other states by checking the content of guide information.

As in the first embodiment, the second embodiment can be applied preferably to video apparatus that are provided with a setting item for the automatic 3D-to-2D converting function (see FIG. 3). Even if the automatic 3D-to-2D converting function is set on, the user can enjoy, in 3D, original 3D video of a prescribed content he or she wants to view in 3D by turning off the 3D-to-2D converting function.

The invention is not limited to the above embodiments themselves and, in the practice stage, may be embodied by modifying constituent elements without departing from the spirit and scope of the invention. And, various inventions can be conceived by properly combining plural constituent elements disclosed in each embodiment.

For example, although in the first embodiment the power indicator 120 and the 3D/3D-2D indicator 121 are provided separately, a single indicator may serve as both of them. That is, the roles of the power indicator 120 and the 3D/3D-2D indicator 121 may be implemented by a single indicator. With this configuration, the number of indicators can be reduced and the probability that the user mistakes the power indicator 120 and the 3D/3D-2D indicator 121 from each other can be lowered.

The first embodiment and the second embodiment can be combined together. More specifically, a TV broadcast receiver may be configured so that a state that the 2D-to-3D converting function is being performed, a state that the 3D-to-2D converting function is being is being performed, a state that neither of these functions is being performed, and other states may be discriminated from each other using both of the light/non-lighting of the 3D/3D-2D indicator 121 and the GUI guide information 300 etc.

The manner of lighting of each indicator is set arbitrarily. For example, a TV broadcast receiver may be configured so that the power indicator 120 is not flashed and the 3D/3D-2D indicator 121 is flashed. This configuration allows the user to easily discriminate between the power indicator 120 and the 3D/3D-2D indicator 121 because the former is lit continuously and the latter is flashed.

1. An information output control apparatus, comprising:
a reception module configured to receive a 3D or 2D video signal;
a video processor configured to output a 3D or 2D video signal, based on the received video signal;
an indicator configured to be turned on/off; and
a controller configured to control lighting/non-lighting of the indicator,
wherein the video processor includes a conversion module configured to perform a conversion processing to convert the received 3D video signal into the 2D video signal, and
wherein the controller controls the lighting/non-lighting of the indicator in accordance with an operating state of the video processor to thereby indicate whether the conversion processing is being performed or not.

2. The apparatus of claim 1,
wherein the controller controls the indicator
to emit a first color when the video processor outputs the 2D video signal by performing the conversion processing, and
to emit a second color that is different from the first color or to be kept off when the video processor outputs the 2D video signal without performing the conversion processing.

3. The apparatus of claim 2,
wherein the controller controls the indicator to emit a third color that is different from the first color and the second color when the video processor outputs the 3D video signal.

4. The apparatus of claim 1,
wherein the controller controls the lighting/non-lighting of the indicator to further indicate whether the information output control apparatus is powered on or off.

5. The apparatus of claim 1,
wherein the controller includes:
a judging module configured to judge whether the reception module is receiving the 3D video signal or the 2D video signal; and
a selection menu display controller configured to display a selection menu for allowing a user to set that whether the 3D video signal should be automatically converted into the 2D video signal when the judging module judges that the reception module is receiving the 3D video signal.

6. An information output control apparatus, comprising:
a reception module configured to receive a 3D or 2D video signal;
a video processor configured to output a 3D or 2D video signal, based on the received video signal; and
an information output controller configured to control the video processor to output guide information together with the 3D or 2D video signal,
wherein the video processor includes a conversion module configured to perform a conversion processing to convert the received 3D video signal into the 2D video signal, and
wherein the information output controller controls the video processor to output, upon channel switching of a video signal, the guide information to include information indicating that the conversion processing is being performed.
